(19) United States
(12) Patent Application Publication
(10) Pub. No.: US 2008/0189297 A1
(43) Pub. Date: Aug. 7, 2008

(54) Securely Storing and Accessing Data

(76) Inventor: Carl Goran Schultz, Esbo (FI)

Correspondence Address: ERICSSON INC., 6300 LEGACY DRIVE, M/S EVR 1-C-11, PLANO, TX, 75024, US

(21) Appl. No.: 12/064,261

(22) PCT Filed: Aug. 14, 2006
(86) PCT No.: PCT/EP2006/065294

§ 371 Date: Feb. 20, 2008

(30) Foreign Application Priority Data
Aug. 22, 2005 (GB) 0517120.2

(51) Int. Cl. G06F 17/30

(52) U.S. Cl. 707/10

(57) ABSTRACT

A method of allowing members of a group to access a plurality of data blocks stored at one or more storage locations, where each data block is associated with at least one of the members. The method comprises providing each of the group members with a shared secret, storing at a storage location, in association with each data block, a tag, the tag having been generated using said shared secret and an identity of the member associated with the data block, sending a request from a group member to a storage location, the request containing the tag of another group member, and upon receipt of said request at the storage location, identifying said tag and sending to the requesting member the data block associated with the tag.

### FIELD OF THE INVENTION

The present invention relates to securely storing and accessing data and in particular to securely storing data on a centrally accessible server such that it can be accessed by client terminals.

### BACKGROUND OF THE INVENTION

There are a number of applications in which is desirable to enable members of a group, each possessing a client terminal, to access one another's data stored on a publicly accessible server. For example, consider the case of a location service, where members of a group wish to be able to obtain information about the location of each another. Each member is able to directly or indirectly upload their current location to the central server. This uploading process is assumed to be secure. A member wishing to download location information for another group member will need to send a request to the central server identifying the member for whom the information is required. In order to introduce a level of security into such a system, the location data may be encrypted with an encryption key, with the decryption key being known to each of the group members.

A potential weakness in this approach is that the members' identities are exchanged in plain text. A third party intercepting location data sent from the server to a group member, or receiving a group member's location as a result of sending a request to the server, will be able to match the encrypted location data to a particular group member. This could be useful to the third party as it would, at the very least, indicate to that party when the group member has changed location.

### SUMMARY OF THE INVENTION

According to a first aspect of the present invention there is provided a data storage server comprising:

a first memory for storing a plurality of data blocks, wherein each data block is associated with at least one member of a group of members, each of the group members having a shared secret;

a second memory for storing, in association with each data block, a tag, the tag having been generated using said shared secret and an identity of the member associated with the data block;

a receiver, for receiving a request sent from a group member to the data storage server, the request containing the tag of another group member; and

a processor for, upon receipt of said request, identifying said tag; and

a transmitter for sending to the requesting member the data block associated with the tag.

The data storage server may be adapted such that the data blocks are stored at the data storage server by the group members either directly or via a group manager, the group manager for distributing the shared secret over a secure communication channel.

It is preferred that the shared secret is not known to the data storage server.

The data storage server may comprise means to encrypt the data block sent to the requesting member.

The first and second memories may be embodied in a common memory. Furthermore, the processor may comprise appropriately programmed code.

According to a second aspect of the present invention, there is provided a user terminal for use by a user who is a member of a group, the terminal comprising:

a memory for storing the identities of other group members, and a shared secret; and

processing and transceiver means for generating and sending a request to a data storage server, the request containing the tag of another group member and the tag being generated or identified using the identity of that other group member and the shared secret, and for receiving from the data storage server data associated with the other member.

The user terminal may comprise means to encrypt messages sent to the data storage server.

According to a third aspect of the present invention, there is provided a method of allowing members of a group to access a plurality of data blocks stored at one or more storage locations, where each data block is associated with at least one of the members, the method comprising:

providing each of the group members with a shared secret;

storing at a storage location, in association with each data block, a tag, the tag having been generated using said shared secret and an identity of the member associated with the data block;

sending a request from a group member to a storage location, the request containing the tag of another group member; and

upon receipt of said request at the storage location, identifying said tag and sending to the requesting member the data block associated with the tag.

It is preferred that the shared secret is distributed to the group members by a group manager over a secure communication channel.

The data blocks may be stored by group members at a storage location either directly, or via the group manager.

In a preferred embodiment, the shared secret is not known to the or each storage location.

The group members and the or each storage location may be provided with keys of an asymmetrical key pair, and data sent between the group members and the storage location(s) in one direction is encrypted with a first of the keys, whilst a second of the keys is used to encrypt data sent in the other direction.

Group members may be provided with a public key and a storage location for each of the other group members, in which case the data blocks stored at the storage location(s) are encrypted with the private key of the owning group member.

It is preferred that a group member's tag is generated by applying a one-way function to the member's identity concatenated with the shared secret, in which case the one way function may be a hash function, e.g. SHA-1.

The message exchange between the member and the storage location may be encrypted.

A group manager may be provided that is able to authenticate and authorise each of the group members.

According to a fourth aspect of the present invention there is provided apparatus for allowing members of a group to access a plurality of data blocks, where each data block is associated with at least one of the members, the apparatus comprising:

a user terminal associated with each group member, each user terminal comprising a memory for storing the identities of other group members, and a shared secret; and

one or more data storage servers, the or each server comprising a memory for storing a data block for each of one or more of the group members, and a tag for each data block, the tag having been generated using said shared secret and an identity of the member associated with the data block,

wherein each user terminal comprises processing and transceiver means for generating and sending a request to a data storage server, the request containing the tag of another group member, and the or each storage server comprises processing and transceiver means for receiving said request, identifying said tag, and sending to the requesting terminal the data block associated with that tag.

The apparatus may further comprise a group manager, the group manager comprising means to distribute the shared secret to the group members.

### BRIEF DESCRIPTION OF THE DRAWINGS

FIG. 1 illustrates schematically a procedure for storing and accessing data on a central, publicly accessible server; and

FIG. 2 illustrates schematically a process for removing a member from a member's group.

### DETAILED DESCRIPTION OF CERTAIN EMBODIMENTS

Consider an electronic communication network comprising a central, publicly accessible server which is permanently on-line. Client terminals are able to communicate with the central server over some (assumed) insecure link. An example might be a web server which can be contacted by mobile terminals over a cellular network. A group management server can also be contacted by certain client terminals belonging to a members' group. Authentication and authorisation procedures are used between the group members and the group management server to ensure security. The group management server does not need to be permanently on-line.

Members' data is stored at one or more central storage locations by the group management server (typically, all members will share a common storage location, e.g. a centrally accessible server, but this need not be the case). Again, authentication and authorisation procedures are used to secure communications between the storage location(s) and the group management server. At the storage location(s), data for each member is “tagged” by a tag that identifies the member to the group and the group management server, but which hides that identity from the central server and other third parties. This mechanism is described further as follows, where:
X public identity for group member X (this may be a name or nickname, for example)
D_X secret data for group member X
PK_X public key for group member X
SK_X secret key for group member X
L_X storage location used by group member X for his group data (e.g. represented by a URL)
GS group secret which is changed by group manager when a group member is removed
GE group encryption key for use by central server
GD group decryption key for use by group members [GE and GD represent an asymmetric key pair]
GE{X} group member X's identity encrypted with his group public key

The possession of these components by the various entities is as follows:

The group management server possesses the public user identities X for all group members. It is also responsible for generating the key group GS, GE, GD.

User X possesses its own public identity X and asymmetric key pair PK_X, SK_X. It possesses the key group GS, GD, as well as a list of the current group members (Y) and respective information triplets Y, PK_Y, L_Y.

The storage location(s) possess the key GE and a set of data pairs each comprising an “anonymisation” identity tag and a corresponding encrypted data block. The identity tag has the form Hash{X∥GS}, where the hash used is keyless, e.g. SHA-1, whilst the data block D_A is encrypted using the group member's secret key, i.e. SK_X{D_X}. It will be understood that a central location does not have access to the member identity X and therefore cannot match the location information to that member. Similarly, any non-group member downloading the location information using a tag (where the tag may have been obtained by eavesdropping on communications between the group members and the central location) cannot match that information to the corresponding member.

The operation of the secure access system will be clear from the following examples.

User Update of Member's Own Information

The group management server has write access to all storage locations used by the group, and acts as a middleman between the group members and the central location. [Of course, this role of the group management server may be unnecessary where the group members have a direct authenticated relationship with the storage locations.]

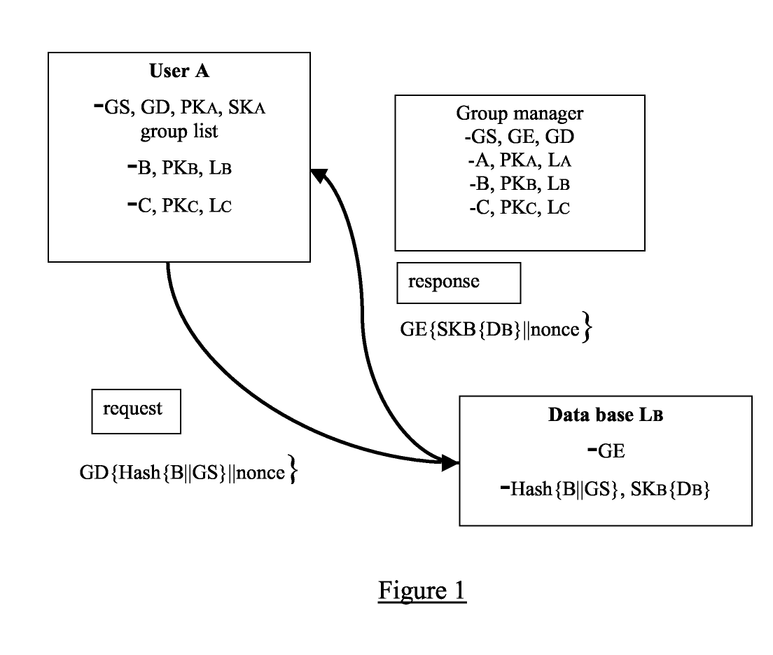

Access (FIG. 1)

Group member A wants member B's data D_B. A generates the tag for user B, encrypts it using a nonce and the key GD, i.e. GD{ Hash{B∥GS}∥nonce}, and sends this to storage location L_B. The storage location identifies the presence of the Hash{B∥GS} tag and returns to A the encrypted data block for group member B, further encrypted using a nonce and the key GE, i.e. GE{SK_B{D_B}∥nonce}. Member B decrypts the data block using first the key GD, strips out the nonce, and decrypts the result using the public key of member B.

It will be appreciated that, whilst not essential, the use of the further encryption procedure using GD, GE adds a further level of security to the system. Use of the public-private key pairs to encrypt and decrypt the data blocks allows a member to authenticate a received data block.

Introduction of a New Group Member C

The group management server sends to the new user C, the keys GS, GD and the triplet (X, PK_X, L_X) for all other group members. It also sends the triplet (C, PK_C, L_C) to all other group members. If data for new group member C is available, the group management server will send to the storage location chosen by or assigned to member C, i.e. L_C, the data pair: Hash{C∥GS}, SK_C{D_C}.

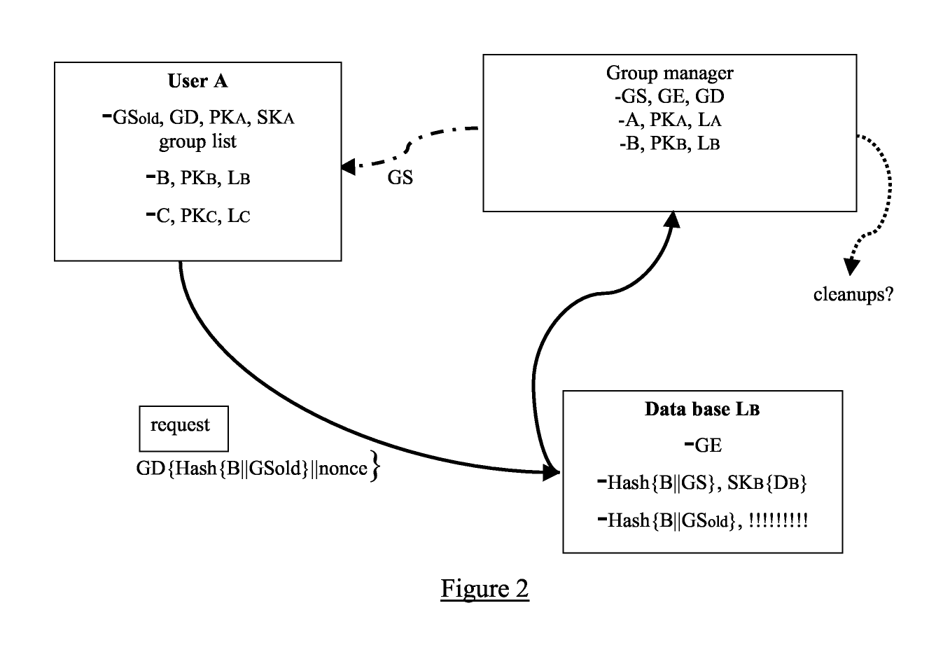

Removal of a Group Member C (FIG. 2)

The removal of a group member in its simplest form involves removing his entry from the corresponding storage location. However, to prevent future access using the group information which the removed user still possesses, the group secret GS has to be changed by the group management server. This involves moving all the data from the old tags to the new tags, leaving in place the old tags for the benefit of members who are not currently on line.

The tag for member C, Hash{C∥GS}, is removed from the storage location L_C. The group management server generates a new group key GS, and new identity tags for all remaining group members. It forwards GS to the remaining group members who are currently on-line (i.e. contactable), and sends the new identity tags to the storage location(s) together with a mapping to the old tags. The storage location(s) replace the old tags with the new tags, and may also retain the old tags to act as a trigger: a request sent to a storage location with an expired GS results in the new GS being sent by the group management server to the (authenticated requesting member).

It will be appreciated by the person of skill in the art that various modifications may be made to the above described embodiments without departing from the scope of the present invention. In one example, the data for a group member that is stored at a storage location together with that member's tag, may be a pointer (and password) to another location (e.g. URL) at which the member's data is stored.

1. A data storage server comprising:
a first memory for storing a plurality of data blocks, wherein each data block is associated with at least one member of a group, each of the group members having a shared secret;
a second memory for storing, in association with each data block, a tag, the tag having been generated using said shared secret and an identity of the member associated with the data block;
a receiver, for receiving a request sent from a group member to the data storage server, the request containing the tag of another group member;
a processor for, upon receipt of said request, identifying said tag; and
a transmitter for sending to the requesting member the data block associated with the tag.

2. The data storage server according to claim 1, the data storage server being operable for storing the data blocks at the data storage server by the group members either directly or via a group manager, the group manager for distributing the shared secret over a secure communication channel.

3. The data storage server according to claim 1, wherein the shared secret is not known to the data storage server.

4. The data storage server according to claim 1, comprising means to encrypt the data block sent to the requesting member.

5. The data storage server according to claim 1, wherein the first and second memories are embodied in a common memory.

6. A user terminal for use by a user who is a member of a group, the terminal comprising:
a memory for storing the identities of other group members, and a shared secret; and
processing and transceiver means for generating and sending a request to a data storage server, the request containing the tag of another group member and the tag being generated or identified using the identity of the another group member and the shared secret, and for receiving from the data storage server data associated with the other member.

7. The user terminal according to claim 6, comprising means to encrypt messages sent to the data storage server.

8. A method of allowing members of a group to access a plurality of data blocks stored at one or more storage locations, where each data block is associated with at least one of the members, the method comprising;
providing each of the group members with a shared secret;
storing at a storage location, in association with each data block, a tag, the tag having been generated using said shared secret and an identity of the member associated with the data block;
sending a request from a group member to a storage location, the request containing the tag of another group member; and
upon receipt of said request at the storage location, identifying said tag and sending to the requesting member the data block associated with the tag.

9. The method according to claim 8, wherein said shared secret is distributed to the group members by a group manager over a secure communication channel.

10. The method according to claim 9, wherein the data blocks are stored by the group members at a storage location either directly, or via the group manager.

11. The method according to claim 8 wherein the shared secret is not known to each storage location.

12. The method according to claim 8 wherein the group members and each storage location are provided with keys of an asymmetrical key pair, and data sent between the group members and the storage location(s) in one direction is encrypted with a first of the keys, whilst a second of the keys is used to encrypt data sent in the other direction.

13. The method according to claim 8 wherein group members are provided with a public key and a storage location for each of the other group members, and the data blocks stored at the storage location(s) are encrypted with the private key of the owning group member.

14. The method according to claim 8 wherein a group member's tag is generated by applying a one-way function to the member's identity concatenated with the shared secret.

15. The method according to claim 14, wherein the one way function is a hash function.

16. The method according to claim 8 wherein the message exchange between the member and the storage location is encrypted.

17. The method according to claim 8 wherein a group manager is provided that is able to authenticate and authorize each of the group members.

18. An Apparatus for allowing members of a group to access a plurality of data blocks, where each data block is associated with at least one of the members, the apparatus comprising:
a user terminal associated with each group member, each user terminal comprising a memory for storing the identities of other group members, and a shared secret; and
one or more data storage servers, the o each data storage server comprising a memory for storing a data block for each of one or more of the group members, and a tag for each data block, the tag having been generated using said shared secret and an identity of the member associated with the data block,
wherein each user terminal comprises processing and transceiver means for generating and sending a request to a data storage server, the request containing the tag of another group member, and the each data storage server comprises processing and transceiver means for receiving said request, identifying said tag, and sending to the requesting terminal the data block associated with that tag.

19. The Apparatus according to claim 18, further comprising a group manager, the group manager comprising means to distribute the shared secret to the group members.
